(19) United States
(12) Patent Application Publication
(10) Pub. No.: US 2018/0145403 A1
(43) Pub. Date: May 24, 2018

(54) SEGMENTED ANTENNA RADOME

(71) Applicant: COMMSCOPE TECHNOLOGIES LLC, Hickory, NC (US)

(72) Inventors: Allan Mitchell TASKER, Kirkclady Fife (GB); Matthew R. LEWRY, Limekilns Fife (GB)

(21) Appl. No.: 15/571,963

(22) PCT Filed: May 17, 2016
(86) PCT No.: PCT/US2016/032876

§ 371 Date: Nov. 6, 2017

Related U.S. Application Data
(60) Provisional application No. 62/164,865, filed on May 21, 2015.

(51) Int. Cl. H01Q 1/42; H01Q 1/00; H01Q 15/16

(52) U.S. Cl. CPC H01Q 1/424; H01Q 15/16; H01Q 1/002

(57) ABSTRACT

A radome for an antenna assembly includes a plurality of radome segments, each of the segments including a structural layer and an overlying outer layer, each of the segments further comprising a first radial side face, a second radial side face, and a perimeter section. The plurality of radome segments is assembled such that the first side face of each radome segment abuts the second side face of another radome segment to form a fully assembled radome, and the perimeter sections of the radomes together form a perimeter of the radome.

### RELATED APPLICATION

The present application claims priority from and the benefit of U.S. Provisional Patent Application No. 62/164,865, filed May 21, 2015, the disclosure of which is hereby incorporated herein in its entirety.

### FIELD OF THE INVENTION

The current disclosure relates to antenna systems and more particularly, although not exclusively, to radomes for antenna systems.

### BACKGROUND

Microwave dish antennas, which are used for transmission of electromagnetic-radiation signals, are typically outfitted with a radome for outdoor operation. The radome provides protection from potential environmental hazards such as rain, snow, ice, dirt, and animals.

FIG. 1 is a perspective view of a conventional antenna assembly 10 comprising a dish antenna 11 outfitted with a radome 12. The dish antenna 11, which has a reflective surface that faces the radome, may also be referred to as a reflector antenna. The radome 12 is mounted on the rim of the dish antenna 11, thereby covering the antenna aperture. The forward transmission direction for the antenna 10 is indicated by an arrow 13.

FIG. 2 is a top view of another conventional antenna system 110 including an antenna mount 111, a dish antenna 112, a cylindrical antenna shield 113, and a radome 114. The antenna mount 111 is used to mount the antenna system 110 onto a mounting structure such as a transmission pole or tower (not shown) and to orient the dish antenna 112 in a desired direction. The antenna shield 113 may comprise a metallic material on its outer, exposed surface and a microwave-absorbent material on its inner surface. The antenna shield 113 functions to attenuate unwanted radiation from the antenna 112—e.g., radiation not generally in the forward transmission direction for the antenna 112 indicated by arrow 115.

Ideally, a radome would be completely transparent to the signals transmitted or received by its corresponding antenna. In practice, radomes are designed to minimize interference with that transmission and/or receipt of signals by the antenna. Consequently, radomes are typically made from non-conductive materials. Conventional dish radomes, such as the radomes 12 of FIG. 1 and 114 of FIG. 2, may be made of a flexible material such as a polymer fabric that is stretched taught over a corresponding antenna aperture.

### SUMMARY

As a first aspect, embodiments of the invention are directed to a radome for an antenna assembly. The radome comprises a plurality of radome segments, each of the segments including a structural layer and an overlying outer layer, each of the segments further comprising a first radial side face, a second radial side face, and a perimeter section. The plurality of radome segments is assembled such that the first side face of each radome segment abuts the second side face of another radome segment to form a fully assembled radome, and the perimeter sections of the radomes together form a perimeter of the radome.

As a second aspect, embodiments of the invention are directed to an antenna assembly, comprising: a reflector antenna having a reflective surface; a radome comprising a plurality of assembled radome segments, each of the segments comprising a first radial side face, a second radial side face, and a perimeter section, wherein the first side face of each radome segment abuts the second side face of another radome segment to form a fully assembled radome, and the perimeter sections of the radomes together form a perimeter of the radome; and a rim that encircles the radome, the reflector antenna being mounted on the rim to form a cavity between the radome and the reflective surface of the reflector antenna.

### BRIEF DESCRIPTION OF THE FIGURES

FIG. 1 is a perspective view of a conventional antenna assembly.

FIG. 2 is a top view of another conventional antenna system.

FIG. 3 is a side cross-sectional view of an exemplary antenna system similar to that of FIG. 1, but with a rigid radome.

FIG. 4A is a perspective view of a four-segment segmented radome with one of the segments shown in ghost outline in accordance with one embodiment of the present invention.

FIG. 4B is a perspective view of an exemplary radome segment of the segmented radome of FIG. 4A.

FIG. 5A is a perspective view of a five-segment segmented radome with one of the four perimetric segments shown in ghost outline in accordance with another embodiment of the present invention.

FIG. 5B is a perspective view of an exemplary perimetric radome segment of the segmented radome of FIG. 5A.

FIG. 5C is a side cross-sectional view of segmented radome EA of FIG. 5A.

### DETAILED DESCRIPTION

The present invention is described with reference to the accompanying drawings, in which certain embodiments of the invention are shown. This invention may, however, be embodied in many different forms and should not be construed as limited to the embodiments that are pictured and described herein; rather, these embodiments are provided so that this disclosure will be thorough and complete, and will fully convey the scope of the invention to those skilled in the art. It will also be appreciated that the embodiments disclosed herein can be combined in any way and/or combination to provide many additional embodiments.

Unless otherwise defined, all technical and scientific terms that are used in this disclosure have the same meaning as commonly understood by one of ordinary skill in the art to which this invention belongs. The terminology used in the below description is for the purpose of describing particular embodiments only and is not intended to be limiting of the invention. As used in this disclosure, the singular forms “a”, “an” and “the” are intended to include the plural forms as well, unless the context clearly indicates otherwise. It will also be understood that when an element (e.g., a device, circuit, etc.) is referred to as being “connected” or “coupled” to another element, it can be directly connected or coupled to the other element or intervening elements may be present. In contrast, when an element is referred to as being “directly connected” or “directly coupled” to another element, there are no intervening elements present.

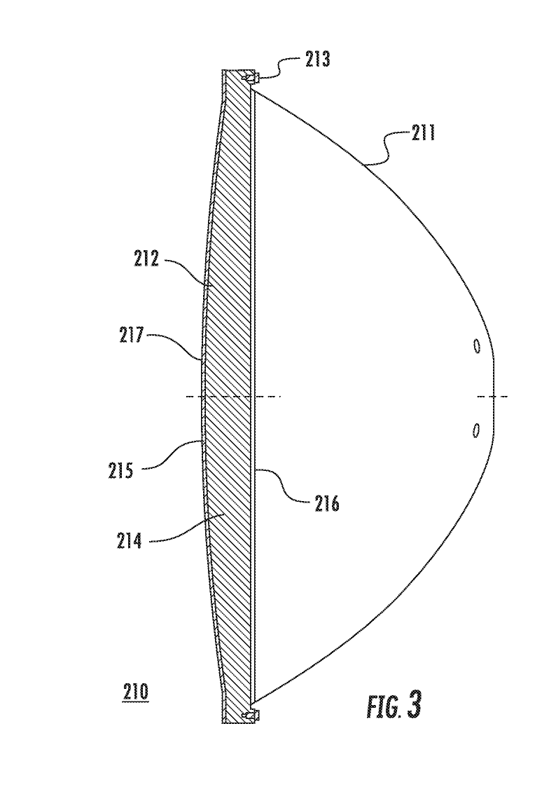

Referring now to the figures, FIG. 3 is a side cross-sectional view of an exemplary antenna system 210 comprising an antenna dish 211 and a rigid radome 212. The radome 212 is attached to the rim of the antenna dish 211 with fasteners 213 (such as bolts, screws or the like). The radome 212 comprises a structural layer 214 and an outer layer 215. The structural layer 214 may comprise, for example, a low-density foamed polymer material, such as (without limitation) polystyrene, polyurethane, polyethylene, or polypropylene. The radome 212 may alternatively be made of any other suitable rigid material such as, for example, a rigid higher-density polymer or wood. Exemplary materials for the structural layer are also discussed in U.S. patent application Ser. No. 14/066,755, filed Oct. 30, 2013, the disclosure of which is hereby incorporated herein in its entirety.

The outer layer 215 of the radome 212, which may be coated or sprayed onto the structural layer 214 to form a coating or film, is on the exposed, outer side of the radome 212, i.e., the side facing away from the antenna dish 211. The outer layer 215, which may have a higher density than the structural layer 214, can provide additional protection for the antenna dish and may also protect a foamed polymer of structural layer 214 from potential environmental hazards such as ultra-violet (UV) radiation and/or moisture, which might otherwise degrade the foamed polymer. The outer layer 215 may comprise, for example and without limitation, one or more of polycarbonate, acrylonitrile styrene acrylate, polyvinyl chlorate (PVC), polymethyl methacrylate (acrylic glass), thermoplastic polyolefin, ethylene-vinyl acetate (EVA), and acrylonitrile butadiene styrene (ABS). Exemplary materials for the outer layer are also discussed in U.S. patent application Ser. No. 14/066,755, supra.

The structural layer 214 is shown as having a curved outer surface 217 and a flat inner surface 216 so that the structural layer 214 is thicker in its center than around its periphery. Note, however, that alternative implementations of the structural layer may have different cross-sections. For example, both inner and outer surfaces 216, 217 may be flat so that the thickness is constant across the area of the structural layer 214, both surfaces may be curved, or one or both surfaces may have support ribs or other structures thereon.

In some prior embodiments, the structural layer 214 may been molded as a single piece or may have been formed or machined from a larger piece. Some applications require larger-than-typical radomes. As the radome size increases, larger molds (and, potentially, correspondingly larger molding machines) are required, which is likely to increase production costs. In addition, packaging and shipping larger radomes is likely to increase packaging and transportation costs.

According to embodiments of the invention, segmenting a rigid radome into a plurality of segments (which may be configured to be capable of assembly on site) may allow for (i) the use of conventionally sized molding equipment and packaging, as well as (ii) the reduction of transportation costs. Additional benefits may include (i) reducing production costs by manufacturing more numerous and smaller radome segments rather than fewer and larger whole radomes, (ii) designing and building custom-shaped radomes less expensively, and (iii) reducing the expense of replacing damaged radomes by making it possible to replace just the damaged segment rather than the entire radome.

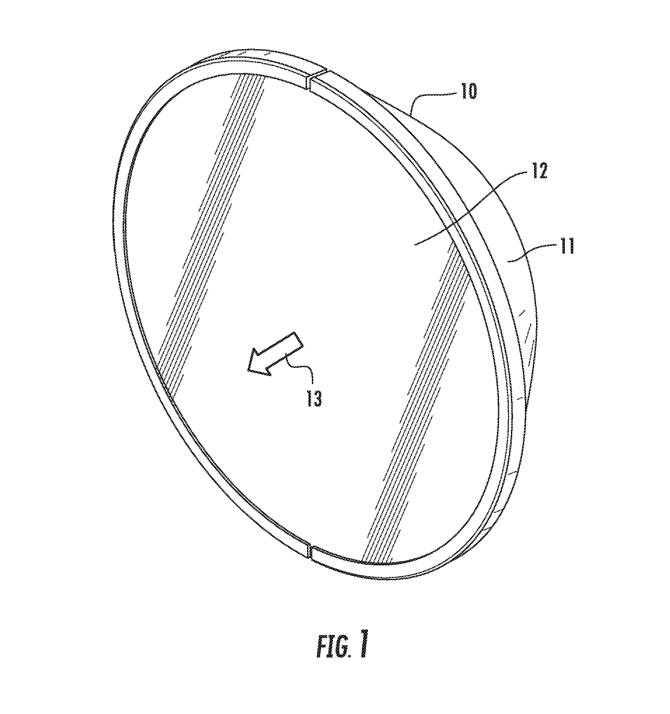

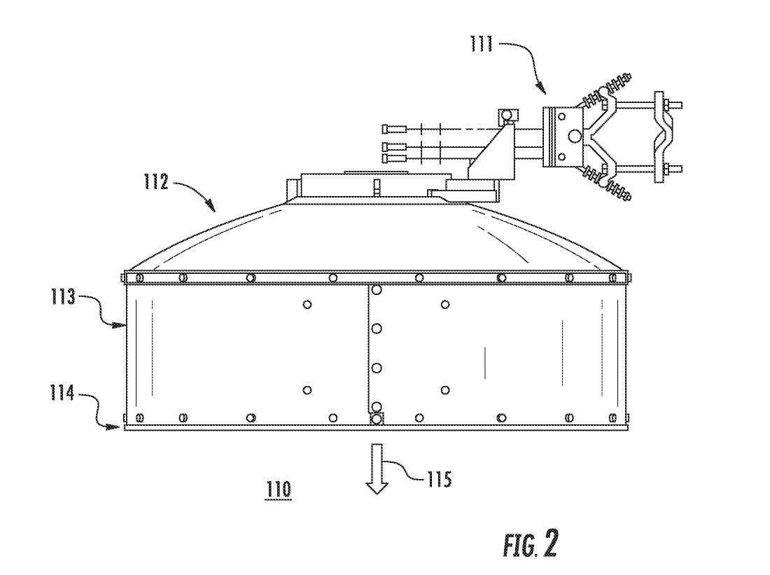

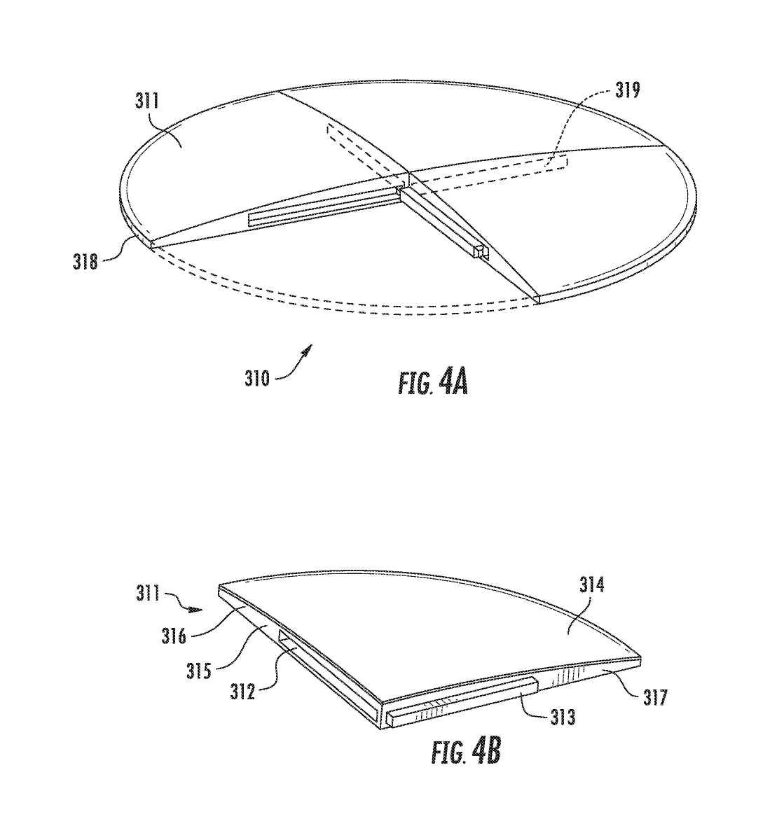

FIG. 4A is a perspective view of a four-segment segmented radome 310 with one of the segments 311 shown in ghost outline in accordance with one embodiment of the present invention. FIG. 4B is a perspective view of an exemplary radome segment 311 of the segmented radome 310. The segmented radome 310 is suitable for use with an antenna such the antennas 11, 112, 211 shown in FIGS. 1-3.

As noted, the segmented radome 310 comprises four perimetric radome segments 311, which are identical to each other. The segments 311 are referred to herein as perimetric segments because they include perimeter sections 318 that correspond to the perimeter of the assembled radome 310, where the perimeter of the radome 310 is configured to mate with a rim and/or aperture on which radome 310 is to be mounted.

The radome segment 311 comprises a structural layer 315, an outer layer 314, and a perimeter section 318. The structural layer 315 may comprise a foamed polymer, such as described above. The outer layer 314 may comprise a polymer coating, such as described above. The perimeter section 318 may comprise (i) the same material as structural layer 315, (ii) the same material as outer layer 314, or (iii) a material different from both the structural layer 315 and the outer layer 314.

Each radome segment 311 comprises a first radial side face 316 and a second radial side face 317. When four radome segments 311 are assembled together to form the radome 310, the respective side faces 316 and 317 are hidden. The first radial side face 316 has a mortise or slot 312 and the second side face 317 has a tenon or tongue 313. The mortise 312 is configured to receive a corresponding tenon 314 on another radome segment 311 to form a mortise and tenon joint 319. Similarly, the tenon 313 is configured to be inserted within a corresponding mortise 312 on yet another radome segment 311 to form another mortise and tenon joint 319. Accordingly, when the entire radome 310 is fully assembled, it has four hidden mortise and tenon joints 319. Once fully assembled, the radome 311 can be mounted, like a conventional unitary radome, on a corresponding aperture of an antenna or antenna shield.

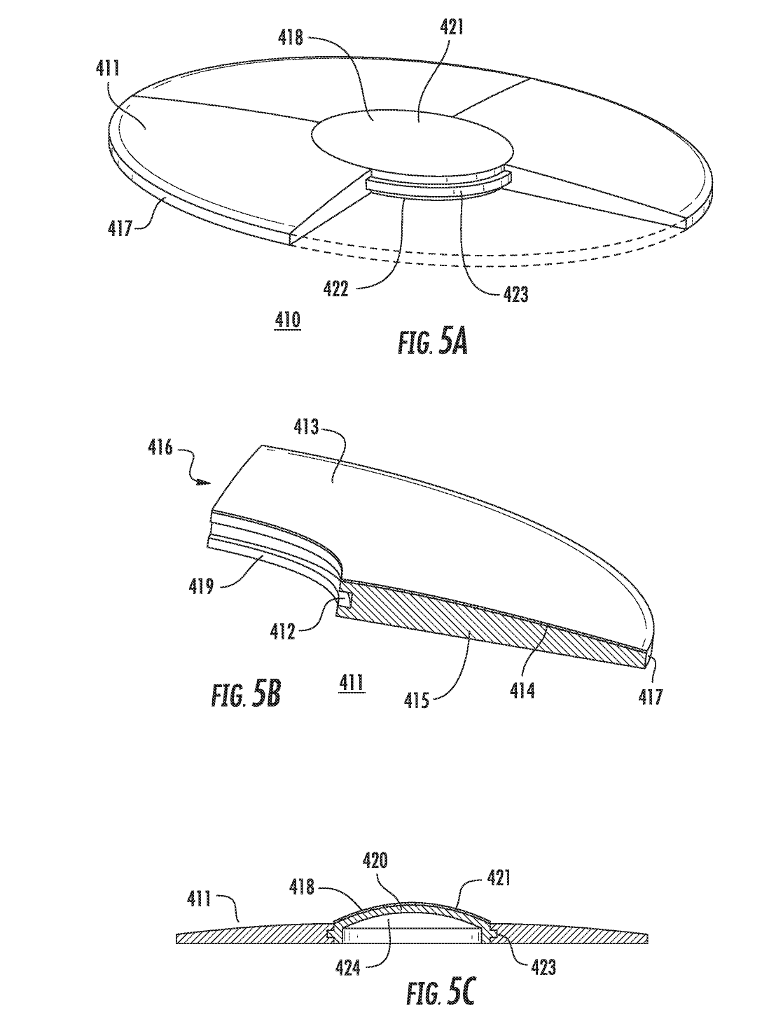

FIG. 5A is a perspective view of a five-segment segmented radome 410 with one of the four perimetric segments 411 in ghost outline in accordance with another embodiment of the present invention. FIG. 5B is a perspective view of an exemplary perimetric radome segment 411 of the segmented radome 410. FIG. 5C is a side cross-sectional view of the segmented radome 410. As can be seen in FIG. 5A, the segmented radome 410 comprises (i) four perimetric radome segments 411, which are identical to each other, and (ii) a central radome segment 421.

Each perimetric radome segment 411 comprises a perimeter section 417, a structural layer 415, and an outer layer 414, which are substantially similar to, respectively, the perimeter section 318, the structural layer 315, and the outer layer 314 of the radome segment 311 of FIG. 4B. A central radome segment 418, which is substantially a hollow, domed/cylindrical structure, comprises a structural layer 420 and an outer layer 421. The structural layer 420 and the outer layer 421 are similar to, respectively, the structural layer 415 and the outer layer 414 of the perimetric radome segment 411, described above.

The central radome segment 418 has a circumferential side face 422, which is the exterior circumferential portion of the central radome segment 418. The side face 422 has a tongue 423, which protrudes out from the circumferential side face 422. Each radome segment 411 comprises first and second radial side faces 415 and 416 and an interior side face 419. The interior side face 419 has a groove 412, which corresponds to an arc of the tongue 423 of the central radome segment 418. The grooves 412 and the tongue 423 are configured to form tongue and groove joints. Accordingly, when the radome 410 is fully assembled, it has four hidden tongue and groove joints (not shown), where the four grooves 412 of the perimetric radome segments 411 are joined to corresponding arcs of the tongue 423 of the central radome segment 418.

The central radome segment 418 has a cavity 424, which includes a raised dome portion. The cavity 419 may be used to provide room for antenna components that may jut out from the corresponding antenna dish, such as, for example, an antenna feeder or a Cassegrain reflector. The radome 411 with a cavity 424 may be a less-costly alternative to using a bowl- or dish-shaped radome for providing room for jutting-out components.

Note that, in alternative implementations, the side faces 415 and 416 of the perimetric radome segments 411 may comprise assembly features configured to form joints, such as, for example, those described elsewhere herein. In some alternative embodiments, the central radome segment 418 is not hollow and has a bottom surface with geometry that matches that of the perimetric radome segments 411. In some alternative embodiments, the central radome segment 418 is not domed and has an outer surface with geometry that matches that of the perimetric radome segments 411.

Although embodiments have been described where an assembled radome comprises four perimetric radome segments, the invention is not so limited. In alternative embodiments, an assembled radome comprises a different plural number of perimetric radome segments (e.g., two, three, five or six radome segments).

Embodiments have been described where radome segments include projections such as tenons and tongues and recesses such as mortises and grooves. However, alternative embodiments may use other types of joints. In some alternative embodiments, joints other than mortise-and-tenon or tongue-and-groove joints are used to assemble together the segments of the segmented radome. For example, radome segments may be joined together with dovetail, box, biscuit, dowel, or any other suitable joints. In some dowel or biscuit implementations, each perimetric radome segment comprises at least one dowel-like or biscuit-like projection and at least one corresponding recess. In other dowel or biscuit implementations, separately formed dowels or biscuits are used—which may be made of the same material as the structural layer—and each radome segment comprises just the corresponding recesses, into which the corresponding dowels or biscuits are inserted to form the joints. It should be noted that radomes may use a combination of different joints to put together an assembled radome. In other words, assembled radomes are not limited to using only one kind of joint.

In some embodiments, an adhesive may be used between radome segments to help secure the joints among the radome segments. In some embodiments, the corresponding side faces of the radome segments may be smooth—i.e. lacking protrusions or recesses—with only an adhesive between them to adhere them and keep the assembled radome together.

Embodiments have been described having radial, circumferential, and/or interior side faces. It should be noted that alternative embodiments may have additional and/or different types of side faces, depending on the particular geometry of a particular radome segment. Side face, as used herein, and unless otherwise indicated, refers to a face of an unassembled radome segment that is configured to be mated to a side face of another radome segment and that will be hidden in the fully assembled radome.

It should be noted that even rigid materials, such as used for the above-described structural layer, have some flexibility. This flexibility may be used in shaping the recesses and corresponding protrusions for a tighter fit. For example, the protrusions may be shaped so that at least part of the protrusion is wider than part of the corresponding recess so that the protrusion would snap into the corresponding recess.

Although embodiments have been described where the perimetric radome segments of a segmented radome are identical, the invention is not so limited. In some alternative embodiments, a segmented radome may be assembled from a plurality of different perimetric segments. The differences may be, for example, in the shape of the segments and/or the types of joints used.

Although embodiments have been described where the antenna dish and the corresponding radome are circular (when viewed head-on), the invention is not limited to circular antennas and radomes. In some alternative embodiments, the antennas and corresponding radomes are rectangular, oval, or of any suitable projection silhouette.

In certain embodiments of the invention, a rigid antenna radome comprises a plurality of component radome segments assembled together using one or more types of joints between corresponding radome segments.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

That which is claimed is:

1. A radome for an antenna assembly, comprising:
a plurality of radome segments, each of the segments including a structural layer and an overlying outer layer, each of the segments further comprising a first radial side face, a second radial side face, and a perimeter section;
wherein the plurality of radome segments is assembled, the first side face of each radome segment abuts the second side face of another radome segment to form a fully assembled radome, and the perimeter sections of the radomes together form a perimeter of the radome.

2. The radome defined in claim 1, wherein the first and second faces of the each radome segment include complimentary mounting features.

3. The radome defined in claim 1, wherein the mounting features comprise a projection in the first side face and a recess in the second side face.

4. The radome defined in claim 1, wherein the mounting features comprises recesses in each of the first and second side faces, and wherein the radome further comprises a separate member that fits within the recesses in the first and second side faces.

5. The radome defined in claim 1, wherein the radome segments are perimeter radome segments that form the entire radome.

6. The radome defined in claim 1, wherein the radome segments comprise a plurality of perimeter radome segments and a central radome segment.

7. The radome defined in claim 1, wherein the central radome segment includes a hollow cavity.

8. An antenna assembly, comprising:
a reflector antenna having a reflective surface;
a radome comprising a plurality of assembled radome segments, each of the segments comprising a first radial side face, a second radial side face, and a perimeter section, wherein the first side face of each radome segment abuts the second side face of another radome segment to form a fully assembled radome, and the perimeter sections of the radomes together form a perimeter of the radome; and
a rim that encircles the radome, the reflector antenna being mounted on the rim to form a cavity between the radome and the reflector antenna.

9. The antenna assembly defined in claim 8, wherein the first and second faces of the each radome segment include complimentary mounting features.

10. The antenna assembly defined in claim 8, wherein the mounting features comprise a projection in the first side face and a recess in the second side face.

11. The antenna assembly defined in claim 8, wherein the mounting features comprises recesses in each of the first and second side faces, and wherein the radome further comprises a separate member that fits within the recesses in the first and second side faces.

12. The antenna assembly defined in claim 8, wherein the radome segments are perimeter radome segments that form the entire radome.

13. The antenna assembly defined in claim 8, wherein the radome segments comprise a plurality of perimeter radome segments and a central radome segment.

14. The antenna assembly defined in claim 8, wherein the central radome segment includes a hollow cavity.

15. The antenna assembly defined in claim 8, wherein the rim is a distinct and separate component from the reflector antenna.
